(19) United States
(12) Patent Application Publication
(10) Pub. No.: US 2016/0221388 A1
(43) Pub. Date: Aug. 4, 2016

(54) WHEEL COVER RETENTION SYSTEM

(71) Applicant: Forward Metal Craft, Inc., Grand Rapids, MI (US)

(72) Inventors: Kenneth W. Van Oort, Wyoming, MI (US); Alexander W. Schenck, Grand Rapids, MI (US)

(21) Appl. No.: 15/001,642

(22) Filed: Jan. 20, 2016

Related U.S. Application Data
(60) Provisional application No. 62/109,137, filed on Jan. 29, 2015.

(51) Int. Cl. B60B 7/10; F16B 2/24

(52) U.S. Cl. CPC B60B 7/10; F16B 2/248; B60B 2320/10; B60B 2900/121; B60B 2900/112

(57) ABSTRACT

A wheel cover retention system includes a plurality of bent wire retainers that attach a wheel cover to a wheel rim (such as a truck or trailer wheel rim). The retainers are formed from bent metal, and have a first end that snaps into an air-passing opening in the wheel rim, and a second end that hooks onto a wheel cover to hold the wheel cover on the wheel rim in a position centered on the wheel rim. The retention system is particularly useful for semi-trailer aluminum or steel wheels that include air-passing openings for reduced weight, but the present system can be used in other wheel rim arrangements.

### CROSS-REFERENCE TO RELATED APPLICATION

This application claims benefit under 35 USC section 119(e) of U.S. Provisional Application Ser. No. 62/109,137, filed Jan. 29, 2015, entitled WHEEL COVER RETENTION SYSTEM, the entire contents of which are incorporated herein by reference.

### BACKGROUND

The present invention relates to wheel cover retention systems, and more particularly relates to a wheel cover retention system having wire retainers holding a wheel cover on a wheel rim. The system is particularly effective for aerodynamic wheel covers applied to semi-tractor and semi-trailer wheels, but is not limited to only that application.

Fuel is a major expense in the trucking industry, and items to improve miles per gallon, even a small amount, can be very important. Recently, it was discovered that reducing air turbulence around truck wheel rims is a surprisingly good way to improve gas mileage. However, any wheel-mounted device must be durable enough to withstand the harsh environment experienced by truck wheels, including impacts by stones and road debris, abrasion by ice and dirt, harsh treatment from adverse weather conditions, and must withstand the overall difficult environment seen by wheels at road level. Also, any such item preferably should have a good appearance, provide a quick and secure installation, preferably include a minimum of parts, and be competitive in manufacturing and installation cost. Also, it is desirable that any such item be relatively light weight and easy to ship in a compact, low volume container, so that they can be shipped to remote locations at minimal cost. These conflicting requirements have made it difficult to arrive at an optimal solution.

### SUMMARY OF THE PRESENT INVENTION

In one aspect of the present invention, a wheel cover retention system for holding a wheel cover on a wheel rim, comprises a plurality of bent wire retainers having a first end connector adapted to releasably engage an opening in the wheel rim and a second end connector adapted to engage and hold the wheel cover on the wheel rim in a position centered on the wheel rim.

In another aspect of the present invention, an aerodynamic covered wheel apparatus comprises a wheel rim; a wheel cover shaped to engage and aerodynamically cover an outside of the wheel rim; and a plurality of separate elongated retainers securing the wheel cover to the wheel rim.

In another aspect of the present invention, an aerodynamic covered wheel apparatus comprises wheel rim having a hub for mounting to an axle and having air-passing openings in the hub around the axle; a wheel cover shaped to engage and aerodynamically cover an outside of the wheel rim; and a plurality of retainers securing the wheel cover to the wheel rim, the retainers engaging the openings and engaging the wheel cover.

In another aspect of the present invention, a method of retaining an aerodynamic cover to a wheel rim comprises providing the wheel rim with air-passing openings; providing a wheel cover shaped to engage and aerodynamically cover an outside of the wheel rim; providing a plurality of retainers; and securing the wheel cover to the wheel rim using retainers extending between selected of the air-passing openings and the wheel cover.

These and other aspects, objects, and features of the present invention will be understood and appreciated by those skilled in the art upon studying the following specification, claims, and appended drawings.

### BRIEF DESCRIPTION OF DRAWINGS

FIG. 1 is a side view of a rear portion of a semi-trailer with two wheels, the left illustrated one wheel being covered by the present wheel cover system, and the right illustrated one wheel not covered.

FIG. 2 is an exploded perspective view showing the rim and wheel cover and retainer(s) of the left illustrated covered wheel in FIG. 1.

FIGS. 3-4 are perspective views showing one of the bent wire retainers shown in FIG. 2, FIG. 3 showing the retainer in an installed open position, and FIG. 4 showing the retainer in a closed ready-to-install position.

FIG. 5 is a perspective view showing one bent wire retainer attached to and extending laterally from the wheel cover of FIG. 2, the retainer being in an installed position but without the wheel rim being shown.

FIG. 6 is a fragmentary view showing one bent wire retainer attached to and extending laterally from the wheel cover of FIG. 2, the retainer being in an installed position but only showing part of the wheel cover and part of the wheel rim.

FIG. 7 is an axial cross section showing the wheel rim, wheel cover, and one retainer of FIG. 6, the wheel rim having a relatively larger air-passing opening as compared to FIG. 10.

FIG. 8 is a cross section taken along line VIII-VIII in FIG. 7.

FIG. 9 is an axial cross section similar to FIG. 6 but showing a different wheel rim, a same wheel cover, and a same one retainer, the wheel rim having a relatively smaller air-passing opening as compared to the wheel rim in FIG. 6.

FIG. 10 is an axial cross section showing the wheel rim, wheel cover, and one retainer of FIG. 9, the wheel rim having a relatively smaller air-passing opening as compared to FIG. 7.

FIG. 11 is a cross section taken along line XI-XI in FIG. 10

FIG. 12 is a cross-sectional view similar to FIG. 10 but showing the snap-end of the retainer with a different orientation than the snap-end of the retainer in FIG. 10.

### DETAILED DESCRIPTION OF PREFERRED EMBODIMENTS

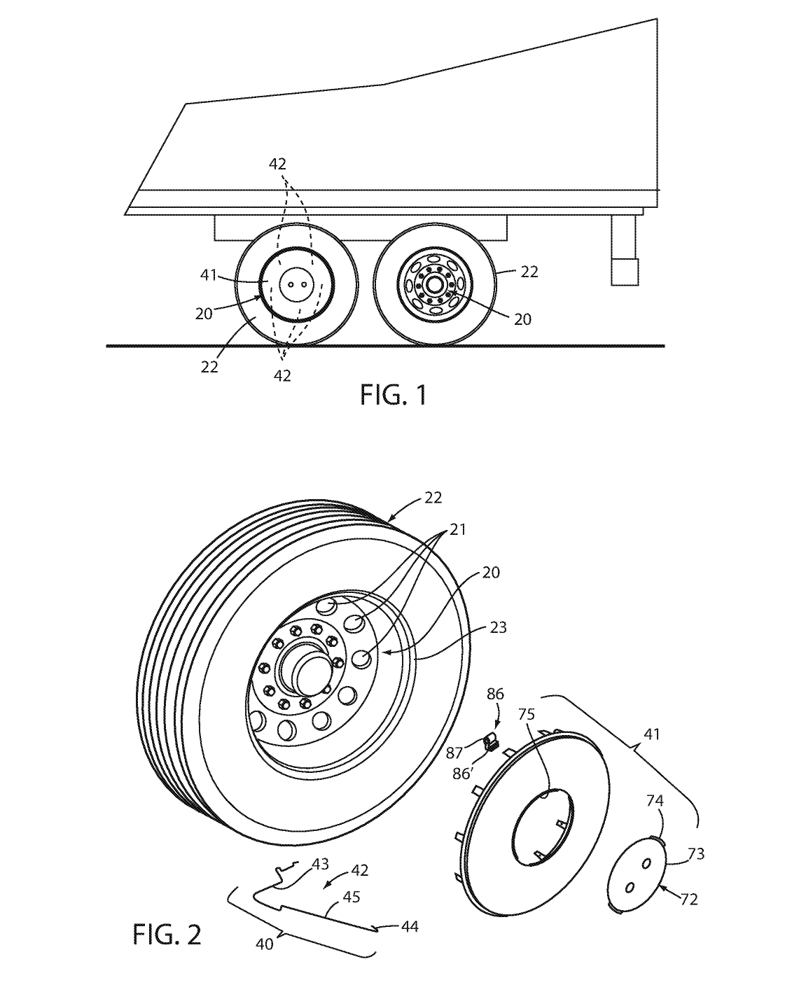

A wheel cover retention system 40 (FIGS. 1-2) is provided for holding an aerodynamic wheel cover 41 on a wheel rim 20. The system 40 includes a plurality of bent wire retainers 42 (such as 5 or more), each having a resilient first end connector 43 that snaps into an air-passing opening 21 in the wheel rim 20 and a hook-shaped second end connector 44 that hooks through a flanged hole in the wheel cover 41. When engaged, the retainers 42 hold the wheel cover 41 on the wheel rim 20 in a position centered on the wheel rim 20. An exterior surface of the wheel cover 41 defines a relatively flat dome-shaped surface having an aerodynamic disc-like shape, which reduces air turbulence and thus leads to improved gas mileage. A large hole in a center of the wheel cover 41 provides access into the truck's associated axle and wheel rim 20 (and to the retainers 42 for installing the retainers 42). The present wheel cover retention system 40 is particularly useful for semi-trailer and semi-tractor wheels (aluminum or steel), because commercial wheels for semi-trucks and trailers include a relatively deep recess that generate a lot of air turbulence. Our testing shows that the present wheel covers 41 can increase miles per gallon of a semi-trailer by a significant amount via reducing wind resistance during transit. However, it is contemplated that the present innovative concepts are not limited to just semis, but instead can be used in many other wheel arrangements.

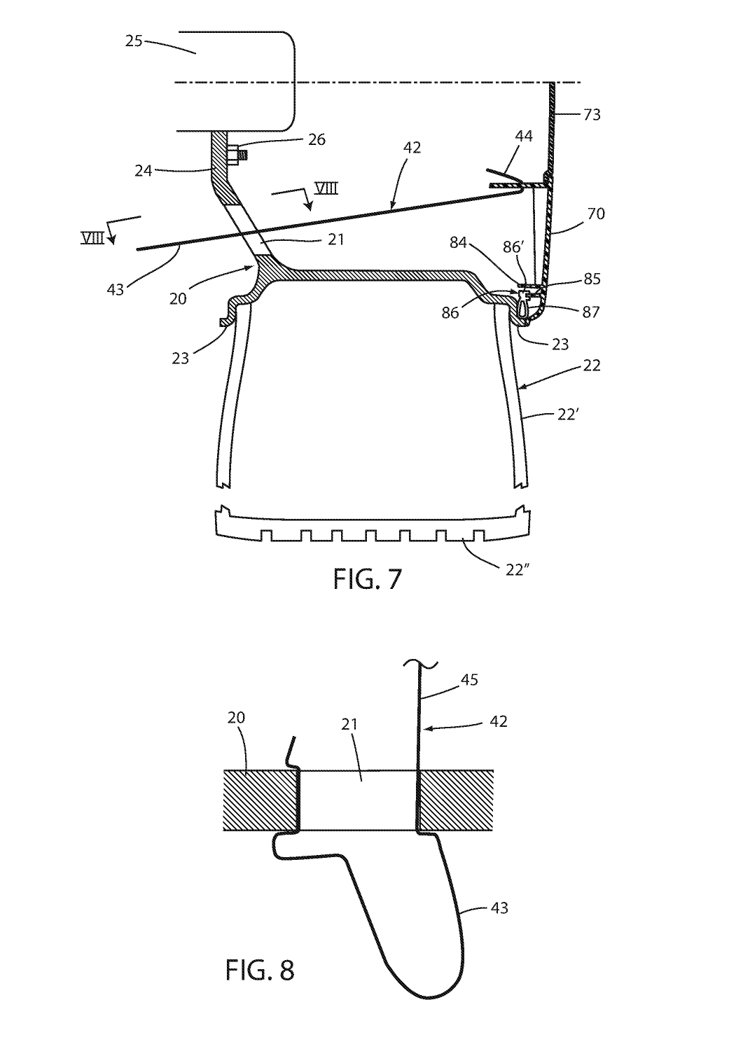

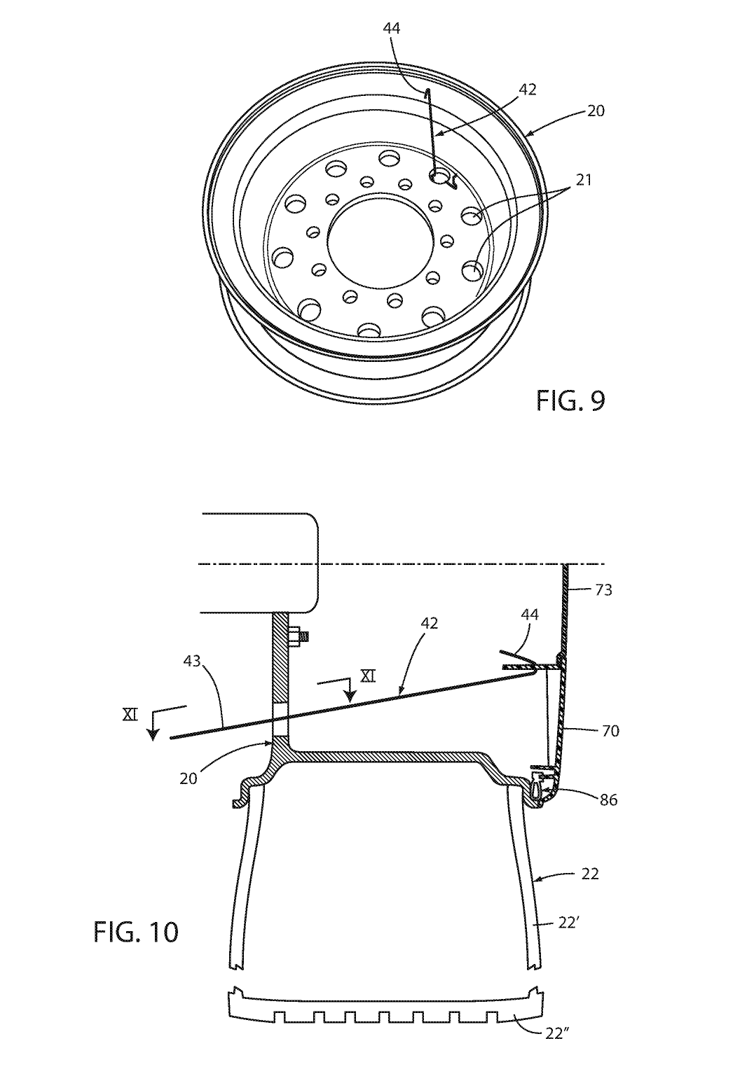

The illustrated rim 20 (FIG. 7) carries an inflated truck tire 22 sealed to and carried by a recess defined by its rim edge 23. The tire 22 includes a sidewall 22′ sealed on the rim edge 23 and includes tread 22″. The rim 20 includes a hub 24 that fits around and is secured to an end of an axle 25. Studs and nuts 26 retain the rim 20 on the axle 25. Air passing openings 21 are spaced radially outwardly from the hub 24 and circumferentially around the rim 20 to reduce a weight of the rim, and also permit air pass-through. The lateral distance from the hub 24 (and also from the openings 21) to an outer surface of the rim edge 23 of the rim 20 is a known dimension for a given style of rim 20. It is noted that the distance may vary for different style rims 20, and also a size and shape of the openings 21 in the rim 20 may vary from one rim style to another. Some rims 20 are steel and have relatively smaller air-passing openings 21, while other rims 20 are aluminum and have larger (or smaller) air-passing openings 21. Both openings 21 reduce weight and save material cost, as well as to provide some air movement around the axle 25, such as for cooling brakes.

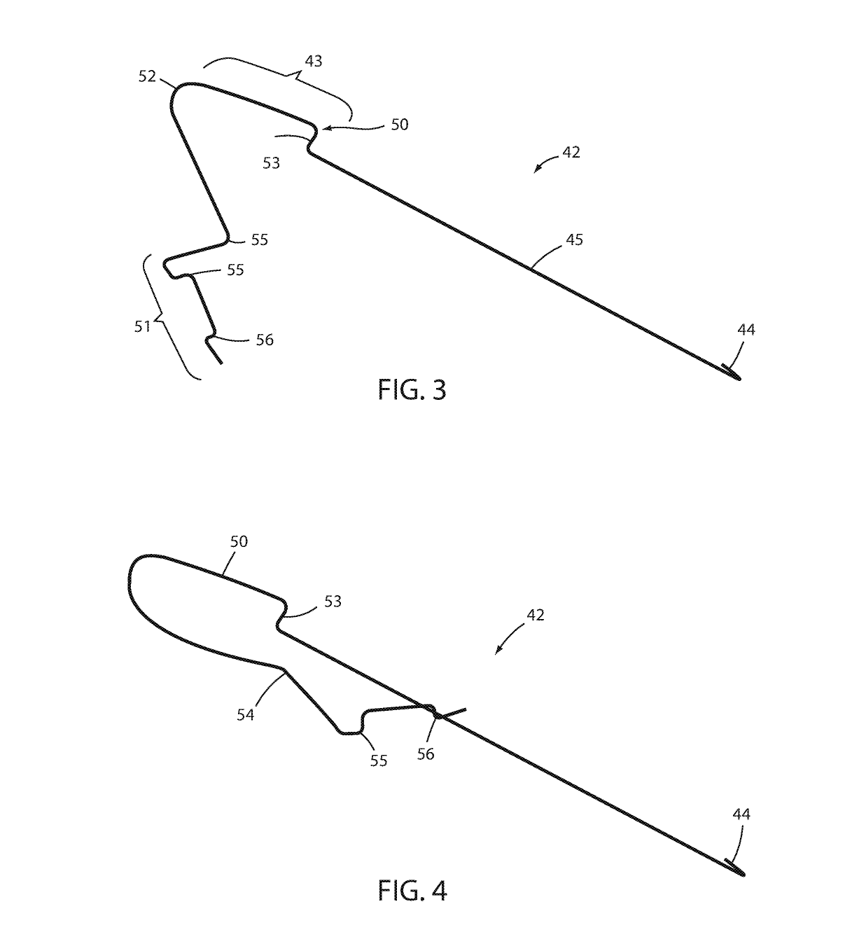

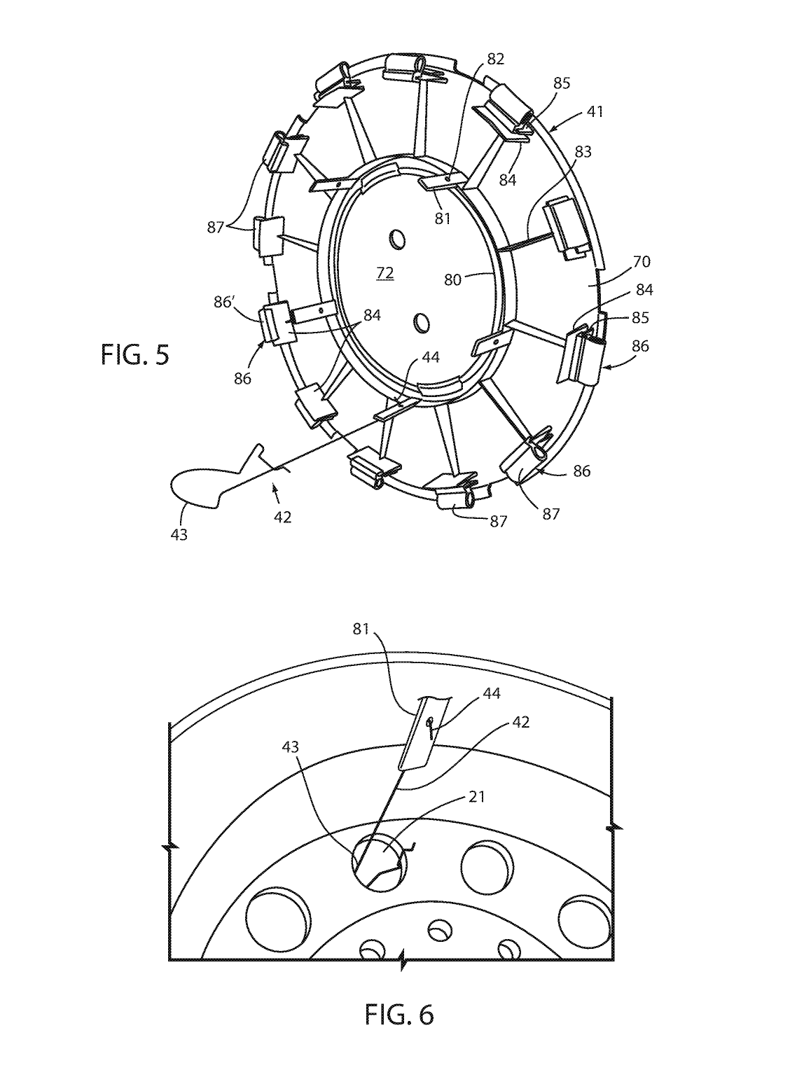

The illustrated retainer 42 is shown in FIGS. 3-4, and its installation is shown in FIGS. 5-8. As noted above, the illustrated retainer 42 (FIGS. 3-4) includes a resilient first end connector 43 (called a “snap connector” herein) and a hook-shaped second end connector 44 (called a “hook connector” herein) joined by an elongated linear wire section 45 (called a “tether section” or “shank” herein). The snap connector 43 includes a tether-side rim-engaging wire section 50, a free-end rim-engaging wire section 51, and a resilient wire section 52 joining the sections 50, 51. The resilient wire section 52 defines a generally pointed or “bullet” shape configured to guide the snap connector 43 into and through a selected opening 21 in the rim 20. The tether-side wire section 50 includes a step 53 (FIG. 3) shaped to engage an outer surface of the rim 20 when the retainer 42 is installed in an air-passing opening 21 (FIG. 8). The free end rim-engaging wire section 51 includes three steps 54-56 (FIG. 3). The two steps 55-56 nearest an end of the bent wire forming the retainer 20 engage opposing surfaces of the rim 20 when the retainer 42 is installed in an air-passing opening 21 (FIG. 8). Notably, the outermost step 56 allows the snap connector 43 to be held in a closed pre-installation position (FIG. 4) to facilitate extending the snap connector 43 through a selected air-passing opening 21. After being positioned within an air-passing opening 21, the installer can then slip open the snap connector 43 to engage the rim 20 as shown in FIG. 8. The hook connector 44 (FIG. 5) is attached to a hole flange in the wheel cover 41 as discussed below.

The wheel cover 40 (FIG. 5) includes a disc-shaped body 70 with centered access opening and (if desired) a mating semi-flat center cover 72 that closes the access opening in its center. The center cover 72 (FIG. 2) can be attached by different means. The illustrated center cover 72 includes an annular flange 73 with tabs 74 that mates against an annular flange 75 on the wheel cover body 70, with the tabs 74 slipping past the flange 75 such that rotation of the center cover 72 secures the center cover 72 to the wheel cover 72. Detents (not shown) can be used to fix the center cover 72 in its installed rotated position. Advantageously, the center cover 72 can be used to provide different logos and appearances, while allowing the body 70 to stay the same. Nonetheless, it is contemplated that the body 70 can be coated, painted, textured, or otherwise treated to provide many different looks, all while maintaining a same shape of the body 70 to minimize tooling costs.

The body 70 of the wheel cover 72 (FIG. 5) is sloped for optimal aerodynamics, and also includes a plurality of ribs to maintain its shape and to provide structure for attaching the retainers 42. Different rib arrangements can be used, depending on functional requirements of a particular installation, and depending on molding requirements desired by the provider of the wheel covers 41. The illustrated ribs include an inside annular rib 80 that extends around the center access opening. Integrally-formed flanges 81 extend from the inside annular rib 80, and include holes 82 for receiving the hook connector 44 of the retainer 40. Radial ribs 83 extend from the inside annular rib 80 to a first outer rib 84. The illustrated first outer rib 84 extends circumferentially, but is discontinuous. It is contemplated that it could be a continuous single rib if desired. A second outer rib 85 extends parallel to and slightly radially outward from the first outer rib 84. As shown in FIG. 7, a foam bulbous dampener 86 includes a pair of closely-spaced fingers 86′ shaped to grip the second outer rib 85, and a bulbous (hollow) portion 87 shaped to abut an outer surface of the rim edge 23 and to abut an inner surface of the wheel cover 41. This allows the dampener 85 to reduce noise and vibration and hence reduce any wear or noise due to relative movement between the wheel cover 41 and the rim 20. It is noted that multiple dampeners can be used if desired, and/or the dampener can be mounted on either or both of the ribs 84, 85. It is also noted that the snap connector 43 is bent in a 90 degree orientation to the hook connector 44, which is best shown by comparing FIGS. 7 and 8. This positions the snap connector 43 so that it engages circumferentially-opposite ends of the air-passing opening 21, thus providing a best engagement and best retention.

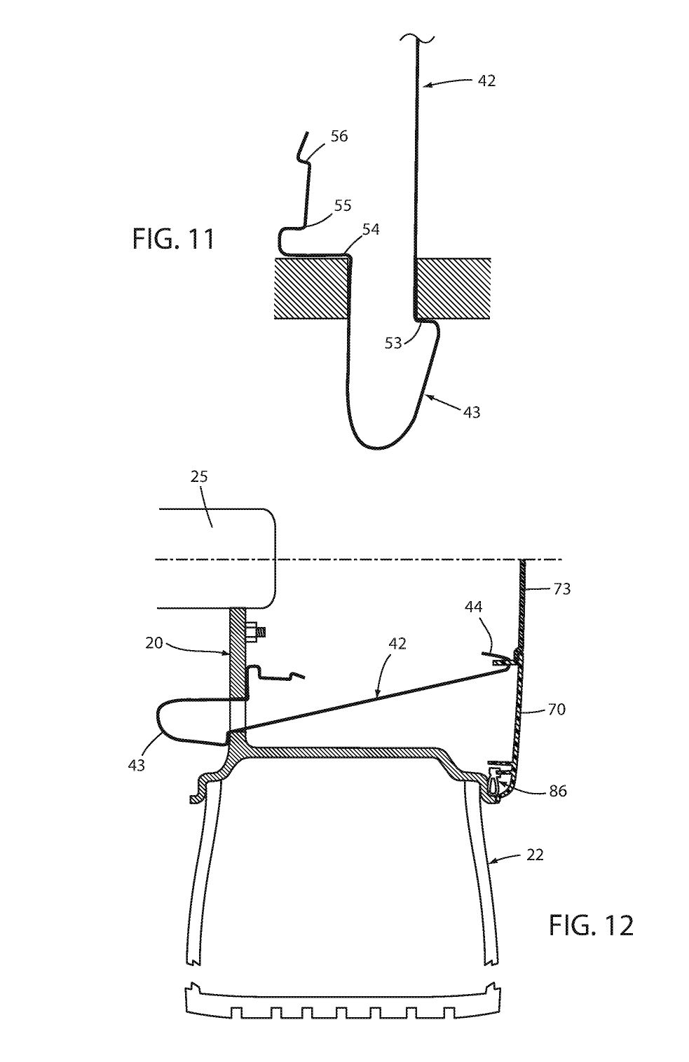

The present retainers 40 are designed to work on wheel rims 20 having a relatively larger air-passing opening 21 (see FIGS. 7-8) as well as on wheel rims having a relatively smaller air-passing opening 21 (see FIGS. 11-12). The engagement of the snap connector 43 to the wheel rim 20 with larger opening 21 is described above, and shown in FIG. 8. The engagement of the snap connector 43 to a wheel rim 20 with smaller opening 21 is shown in FIG. 11. As shown in FIG. 11, the step 54 combines with step 53 to engage opposing surfaces of the wheel rim 20 to secure the retainer 42 to the wheel rim 20. This arrangement allows a single style retainer 42 to be used regardless of which style wheel rim 20 is used.

As shown in FIG. 12, the retainer 42 can be modified to position the snap connector 43 in a same orientation on the retainer 42 as the hook connector 44 if desired, instead of at 90 degrees as previously shown.

There are a variety of different wheel rims in the industry, but two main wheel rims predominate. In a first predominate wheel rim 20, the opening 21 (see FIG. 12) is smaller, such as 1-½″ in size. In a second predominate wheel rim, the opening 21 is larger (see FIG. 8), such as 2-¾″. When the retainers 42 are engaged in the larger opening 21 (FIG. 7), the shank 45 of the retainer 42 extends approximately a known dimension (i.e. about 8-½″) toward the wheel cover 41. It is noted that the shank 45 can be made non-linear or bowed (or another shape) if desired. A non-linear shank 45 allows the shank 45 to flex and adjust lengthwise, providing some tension and adjustability for different circumstances, while still providing adequate retention strength for retainers 42 to hold the wheel cover 41 to a given wheel rim 20. For example, where foam bulbous dampener 86 is eliminated, it may be important to provide the shank 45 with a shape permitting length-adjusting behavior. This can be done by forming the shank 45 into an arc, or forming a V into the shank that permits expansion, or forming a coiled spring arrangement along its length, each of which provide elongation and yet provide resiliency and strength for retention.

It is contemplated that the retainers 42 can be made from a variety of different materials. The illustrated retainers 42 are preferably made from stainless spring steel wire having a diameter of 0.078″. They are dipped in a protective polymeric or non-conductive coating on all areas that may engage an aluminum (or metal) rim 20 in order to prevent galvanic corrosion. The number of retainers used can vary as needed, but it is expected to be at least 5 or more (e.g. 5-8).

The wheel cover 41 (FIG. 2) can be made of any structural material. The illustrated wheel cover 41 is a polymeric material such as ABS or other structural polymer, and can be painted or chromed or otherwise treated for aesthetics.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A wheel cover retention system for holding a wheel cover on a wheel rim, comprising:
a plurality of bent wire retainers having a first end connector adapted to releasably engage an opening in the wheel rim and a second end connector adapted to engage and hold the wheel cover on the wheel rim in a position centered on the wheel rim.

2. The retention system of claim 1, wherein the first end connector includes first and second rim-engaging wire sections and a resilient wire section joining the first and second rim-engaging wire sections so that the first end connector can snap into the opening in the wheel rim.

3. The retention system of claim 1, wherein the first and second wire sections define a narrow leading tip portion and wider trailing portion.

4. The retention system of claim 1, wherein the second end connector includes an end wire section forming a hook.

5. An aerodynamic covered wheel apparatus comprising:
a wheel rim;
a wheel cover shaped to engage and aerodynamically cover an outside of the wheel rim; and
a plurality of separate elongated retainers securing the wheel cover to the wheel rim.

6. The apparatus of claim 5, wherein the retainers comprise bent wire.

7. The apparatus of claim 5, wherein the retainers each have a first end connector releasably engaging an air-passing opening in the wheel rim and a second end connector engaging and holding the wheel cover on the wheel rim in a position centered on the wheel rim.

8. The apparatus of claim 5, wherein the second end connector includes an end wire section forming a hook.

9. The apparatus of claim 5, wherein the first end connector includes first and second rim-engaging wire sections and a resilient wire section joining the first and second rim-engaging wire sections.

10. An aerodynamic covered wheel apparatus comprising:
a wheel rim having a hub for mounting to an axle and having air-passing openings in the hub around the axle;
a wheel cover shaped to engage and aerodynamically cover an outside of the wheel rim; and
a plurality of retainers securing the wheel cover to the wheel rim, the retainers engaging the openings and engaging the wheel cover.

11. The apparatus of claim 10, wherein each of the retainers includes a wheel-cover-engaging end with a narrow leading tip portion and wider trailing portion.

12. A method of retaining an aerodynamic cover to a wheel rim comprising:
providing a wheel rim with air-passing openings;
providing a wheel cover shaped to engage and aerodynamically cover an outside of the wheel rim;
providing a plurality of retainers; and
securing the wheel cover to the wheel rim using retainers extending between selected of the air-passing openings and the wheel cover.

13. The method of claim 12, wherein the step of providing retainers includes forming the retainers of bent wire.

14. The method of claim 12, wherein the step of securing includes separately attaching the retainers between the wheel rim and the wheel cover.

15. The method of claim 12, wherein the step of securing includes hook-attaching the retainers to the wheel cover.

16. The method of claim 12, wherein the step of securing includes snap-attaching the retainers into the air-passing openings of the wheel rim.
